(19) United States
(12) Patent Application Publication
(10) Pub. No.: US 2013/0058611 A1
(43) Pub. Date: Mar. 7, 2013

(54) Photonic crystal optical waveguide solar spectrum splitter

(71) Applicant: Feng Shi, Klamath Falls, OR (US)

(72) Inventor: Feng Shi, Klamath Falls, OR (US)

(21) Appl. No.: 13/137,666

(22) Filed: Sep. 1, 2011

(51) Int. Cl. G02B 6/26

(52) U.S. Cl. 385/50

(57) ABSTRACT

A solar spectrum splitter comprises a series of hollow core optical waveguides. All hollow core optical waveguides are made of photonic crystals. Each of the photonic crystal optical waveguide is mounted inside of the other photonic crystal optical waveguide so as to form a structure in which each of the outer optical waveguide encapsulates all of the inner optical waveguides. Each of the optical waveguides bends out via penetrating through all outer optical waveguides. Wherein, the concentrated sunlight incident into the inner-most hollow core optical waveguide is confined and its components will be extracted out in sequence.

### TECHNICAL FIELD

The present disclosure relates generally to optical spectrometer. More specifically, to one stage photonic crystal optical waveguide solar spectrum splitter.

### BACKGROUND

Rainbow after raining often shows astonishing beauty in sky. The beautiful colors come from the broad band sunlight. When the individual components of the broad band spectrum of sunlight are separated via the refraction of the water drops in wetting air, a spectacular arch forms in sky. As in nature, in scientific fields, it is often necessary to split broad band optical spectrum into their individual components. Particularly, in energy application fields such as concentrating photovoltaic systems, it is necessary to split the concentrated broad band solar spectrum and channel its separated components to certain destinations. For instance, in the design paradigm of ultra-high efficiency concentrating photovoltaic systems, one of the approaches is to separate the concentrated sunlight into its spectral components and channel each of the individual components to band matched elemental solar cells, which are connected into integrated circuit for outputting power in an efficient manner. In the solar spectrum splitter used for ultra-high efficiency integrated solar cell circuit system, the high intensity optical power stream flowing in power processing apparatus is spliced based on wavelength and in the mean time the separated energy components as energy carriers are transmitted to its band matched solar cells. The solar spectrum splitter for ultra-high efficiency photovoltaic application purpose must be efficient both in spectrum splitting and energy transmission.

The instruments used to separate or analyze light according to wavelength are known as spectroscopic instruments or spectrometers. The overall form of most current spectrometers is of an imaging system which consists of 3 principle components [1], collimating unit made of collimating lens, spectral unit, and camera or telescope unit made of focusing lens. The collimating unit collimates the input light into parallel beam light, the spectral unit separates the beam light and the camera or telescope unit output the separated components. In terms of image systems, by locating the spectral unit in the aperture stop of the system, the arrangement of the system is able to form a chromatically altered image of the entrance aperture or field stop. The field of view is defined by a field stop in the front focal plane of the collimating lens. The focusing lens completes the imaging of the field stop.

The spectral unit is the fundamental component of all spectrometers. In and near the visible region of the spectrum, this unit is usually a prism, a grating, a Fabry-Perot etalon, or a version of the Michelson interferometer [1]. These spectral units operate on plane waves. Prisms change the directions of these waves according to wavelengths. The collimating optics creates plane wave from the light emanating from each point in the entrance aperture. The focusing lens brings each plane wave leaving the spectral unit to a different point and makes the output ultimately analyzed spatially.

For energy applications, the current spectrometers based on plane wave interference and material diffraction are unable to fulfill the tasks of diversifying the high density energy current based on wavelength and transmitting separated spectral components with high energy transmission efficiency. In other world the spectrometer for energy application purpose must not only function as spectrum splitter, but also as energy component collector. Specifically, most of the spectrometers heretofore known suffer from a number of disadvantages:

1) As an imaging system, the overall form of most of the current spectrometers can only process beam light and plane waves, but not diffusion light and other types of waves. While, for most solar energy applications, sunlight is a mixture of beam light and diffusion light. The current spectrometers are unable to treat the diffusion light.

2) Most current spectrometers are designed for analyzing incident light to get spectral information. They are not fit for energy processing.

3) In the current spectrometers, the beam light propagates in free space, rather than flows in optical waveguide, therefore energy flowing can't be directed anywhere desirable.

4) The resolving power of the current spectrometers is limited by the spectral separation mechanism.

5) Single spectrometer is unable to cover broad range of spectrum in mean time.

6) The power throughput is limited by the intuitive nature of the current spectrometers, therefore they are not appropriate to be used as power process equipment.

7) The structure of the current spectrometer is complicate.

8) The whole system of the current spectrometers is not compact.

9) The structure of the current spectrometer is composed of precision optical processes, so the whole system is not robust.

10) The current spectrometers are usually used as independent spectral analyzing instruments, they are not easy to be integrated into other systems.

11) The precision optics used in the current spectrometers is expensive.

As can be seen, the intuitive nature of the currently existing spectrometers limit their application to processing beam light and plane waves, they are not able to deal with diffusion light and other type of waves. The collimation optics and output optics are usually necessary for spectrometers to carry out spectrum separation function, this makes the structure of these systems too complicated. The input beam and output of the spectrometers all propagate in free space without guidance, therefore it is not easy to realize energy separation and collect the separated elements of broad band optical spectrum. The current spectrometers are more eligible to analyze spectrum. From the point view of energy application, the mechanisms of the currently existing spectrometers are not efficient in separation and collection of elements of broad optical spectrum. The currently existing spectrometers depend on the aids of input optics and output optics to realize effective separation of broad band spectrum. The systems perform very well in spectral analysis and information process. However, they are not effective in carrying out spectral energy separation of broad band spectrum. Due to the complicate structure of spectrometers, they are not compact. In terms of power transportation, the currently existing spectrometers are not effective.

The appearance of the new materials photonic crystal materials makes it possible to construct spectrometer with disruptive new mechanisms. Some disclosures employ simple photonic crystals to filter out one or more components of broad band beam lights. In their structures, the light and separated components all propagate in free space. In my previous invention U.S. Pat. No. 7,382,958, I disclosed a structure of photonic crystal optical waveguide spectrometer. In this disclosure, a series of photonic crystal optical waveguides and broad band hollow core optical waveguides are assembled into a waveguide chain to process mixed diffusion and beam light. This design paradigm is able to confine the incident light and its separated components and easily guide them to their destinations. The structure is simple, compact and inexpensive. However, some of the components must undergo several focusing and refocusing, as well as coupling processes to be separated. These components involve multiple stage treatment and suffer from energy losses. For energy processing applications, the overall energy transmission efficiency of this apparatus for all components is not satisfied. Recently, a new patent granted to Nadia et al with international patent number WO 2011/046875 A1 discloses a structure for photonic crystal spectrometer. In their disclosure a slab optical waveguide is employed as basis, and arrays of photonic crystal specified for outputting certain components of broad band spectrum are fabricated on or within the exterior surface at the different areas of the slab waveguide. However, their apparatus is designed to “read” optical spectrum, rather than process and transport optical power. So their disclosure involves mainly spectral analysis. In the operation of this apparatus, only input spectrum is guided in optical waveguide, but the output components propagate in free space.

### OBJECTS AND ADVANTAGES

Instead of material diffraction and plane wave interference, this disclosure adopts the disruptive photonic crystal confinement mechanism to separate the broad band solar spectrum. The unique structure of the solar spectrum splitter disclosed in this disclosure ensures the power flowing under guidance. Comparing with my previous patent on photonic crystal optical waveguide spectrum spectrometer U.S. Pat. No. 7,382,958, this disclosure is to realize one stage solar spectrum splitting so as to realize ultra-high energy transmission efficiency and effective spectral separation. This invention employs a series of photonic crystal waveguides specified to confine different components of the incident solar spectrum via tuning the lattice constants of photonic crystals, and arrange them in a co-central structure to trap the broad band solar spectrum. In the structure, each of the photonic crystal waveguides bends out of the apparatus in sequence along the length direction. When the concentrated sunlight incidents into the central most photonic crystal waveguide, it is trapped into the apparatus and then the components are extracted out one by one through the bending of each of the photonic crystal wave guides which compose the solar spectrum splitter.

Through inserting different photonic crystal optical waveguides specified to confine different components of solar spectrum into each other, the multi-stage structure of previous photonic crystal optical waveguide spectrometer disclosed in U.S. Pat. No. 7,382,958 is simplified into just one stage structure. All the components of the incident concentrated sunlight are separated just in once. This ensures low energy loss and high energy transmission in the high intensity power process. The disclosed apparatus is able to treat both beam light and diffusion light. Both the input light and the output separated components are guided in hollow core optical waveguides. Since the photonic crystal optical waveguide can be conveniently specified to confine a certain component by tuning the lattice constant of the photonic crystal, this disclosed structure increases the resolution power of the photonic crystal waveguide spectrometer. This disclosed structure enlarges the range of wavelength that the spectrometer can cover in single instrument in terms of energy application. This disclosed apparatus is simple, compact and robust. Particularly for ultra-high efficiency photovoltaic applications, the disclosed apparatus is easy to be integrated into a solar system. Most importantly, this structure has great potential to be cheap.

### SUMMARY

In summary, this invention provides an apparatus which treat high intensity concentrated sunlight composed with beam light and diffuse light via separating the concentrated solar spectrum into its components. This apparatus process the incident light with a low energy loss and high resolution power in terms of splitting optical spectrum. All the input concentrated sunlight undergoing separating process and the separated power components in the spectrum splitter are under guidance of hollow core optical waveguides. For ultra-high photovoltaic applications, this apparatus guides the separated components to certain solar cells and to certain areas of solar cells. This apparatus is featured in a simple, compact and robust structure, and easy to be integrated into photovoltaic system.

In one embodiment, an optical spectrometer comprises a series of hollow core photonic crystal optical wave guides which are mounted one in another and arranged in a co-central structure. Each of the photonic crystal waveguides specified to confine certain components is bended out the apparatus in sequence and guide each of the components out of the stream of the optical power flowing. Therefore, the high intensity concentrated sunlight is spliced just in one stage and all components are under guidance and guided to certain destinations. Since all optical energy is flowing in hollow air cores, the splitter processes and transports optical power in a very high efficiency.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is a cross section show of the assembly of an example of the spectrometer structure. Only 3 photonic crystal hollow core optical waveguides are shown in this figure, however more optical waveguides can be added to the apparatus. The waveguides are inserted into one another alternatively and bended out one by one.

FIG. 2 is the cross section of the spectrometer structure of FIG. 1. The photonic crystal optical waveguides specified to confine certain components of solar spectrum are arranged in a co-central structure.

### DETAILED DESCRIPTION

Reference will now be made in detail to the present exemplary embodiment, example of which is illustrated in the accompanying drawings. Wherever possible, the same reference numbers will be used throughout the drawings to refer to the same or like parts.

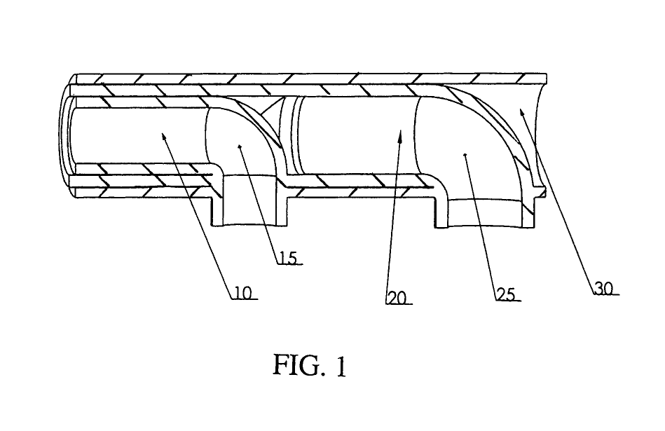

Referring to FIG. 1, the structure of the optical spectrum splitter is an assembly of a series of hollow core wave guides, where the hollow core wave guides are mounted in each other. In FIG. 1, only 3 wave guides are shown, wave guide 10 is mounted inside of the wave guide 20. The wave guide 10 is bended at 15 and turned out the assembly. While, the wave guide 20 extends further, bends at 25 and turns out. The wave guide 30 outside the wave guide 20 extends further, bends and turns out. Many more wave guides can be added outside the out-most wave guide. Each wave guide is specified to confine one of the components of the optical spectrum and therefore able to transport and extract the confined component out.

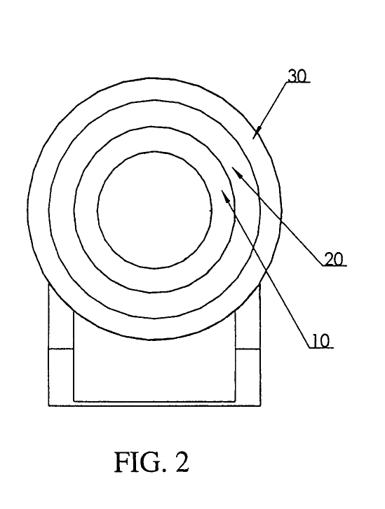

Referring FIG. 2, the hollow core wave guides are inserted alternatively into each other. As shown in FIG. 2, wave guide 10 is inserted into wave guide 20; wave guide 20 is inserted into wave guide 30. Each waveguide is specified to confine one of the components of the optical spectrum. All waveguides are made of photonic crystals.

The work principle of the spectrum splitter is elucidated as the following. The broad band concentrated light composed of beam light, and diffusion light incidents into the hollow core of waveguide 10. One of the components is confined by waveguide 10 and extracted out at the bending 15. Another component is confined by waveguide 20 and extracted out at the bending 25. The third component is confined by waveguide 30 and extracted at its bending. More components can be separated by adding more waveguides at the outside of the outmost waveguide. Waveguides 10, 20, 30 all are made of photonic crystals and each of them are specified to confine a certain components of the broad band spectrum through tuning the band gap locations of photonic crystals.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

### REFERENCE LIST

1. Daniel Malacara, Geometrical and Instrumental Optics, Methods of Experimental Physics, Volume 25, Page 190-237

I claim:

1. A solar spectrum splitter, comprising:
a series of hollow core optical waveguides,
wherein one optical waveguide is inserted in another optical waveguide such that each optical waveguide confine and extract one component of broad band spectrum.

2. The solar spectrum splitter of claim 1, wherein the outer optical waveguide encapsulates all inner optical waveguides.

3. The solar spectrum splitter of claim 1, wherein each of the said hollow core optical waveguides bends out the solar spectrum splitter of claim 1.

4. Each hollow core optical waveguides of claim 3, wherein the optical waveguides bend out in sequence.

5. Each hollow core optical waveguides of claim 3, wherein the inner optical waveguide bends and penetrates through all other outer optical waveguides.

6. The solar spectrum splitter of claim 1, wherein all hollow core optical waveguides are made of photonic crystals.

7. All hollow core optical waveguides of claim 6, wherein each of the photonic crystals is specified to confine a certain component of broad band optical spectrum.

8. The solar spectrum splitter of claim 2, wherein no order for arrangement of inner and outer hollow core optical waveguides.
